(19) United States
(12) Patent Application Publication
(10) Pub. No.: US 2026/0255121 A1
(43) Pub. Date: Aug. 27, 2026

(54) Directivity Control for an Immersive Loudspeaker

(71) Applicant: Samsung Electronics Co., Ltd., Suwon-si (KR)

(72) Inventor: Matthew Ryan McDuffee, Thousand Oaks, CA (US)

(21) Appl. No.: 19/544,575

(22) Filed: Feb. 19, 2026

Related U.S. Application Data
(60) Provisional application No. 63/761,639, filed on Feb. 21, 2025.
(60) Provisional application No. 63/819,484, filed on Jun. 6, 2025.
(60) Provisional application No. 63/820,431, filed on Jun. 9, 2025.

(51) Int. Cl. H04S 7/00; H04R 5/02

(52) U.S. Cl. CPC H04S 7/302; H04R 5/02; H04S 7/307; H04S 2400/11

(57) ABSTRACT

In one embodiment, a method includes creating a control audio signal of a control channel by accessing source audio of a source channel for a source transducer of a speaker enclosure designed to reflect audio from the source transducer off of a surface to a listening position; shaping the control audio so that it has an identical frequency response, over a range of frequencies and when emitted from a main transducer of the enclosure, as the source channel; adjusting a phase of the shaped control audio signal relative to the source channel so that audio in the range of frequencies played at the same time by the source and main transducers creates results in a null at the listening position; adding the shaped, phase-adjusted control audio signal to a main channel; and playing the source audio by the source transducer and the shaped, phase-adjusted control signal by the main transducer.

### PRIORITY CLAIM

This application claims the benefit under 35 U.S.C. § 119 of U.S. Provisional Patent Application Nos. 63/761,639 filed Feb. 21, 2025, 63/819,484 filed Jun. 6, 2025, and 63/820,431 filed Jun. 9, 2025, each of which is incorporated by reference herein.

### TECHNICAL FIELD

This application generally relates to active directivity control for an immersive loudspeaker.

### BACKGROUND

A loudspeaker converts an electrical signal into a corresponding sound. Loudspeakers can be used for playing music, listening to audio content corresponding to video content (e.g., audio of a TV show or a movie), etc. An entertainment system often involves multiple loudspeakers that play audio. For example, an entertainment system may include a pair of left-right stereo loudspeakers, a subwoofer loudspeaker, a center loudspeaker, a pair of left-right surround loudspeakers, and/or a pair of left-right rear surround loudspeakers. The number of loudspeakers in a system are often referred to by an x. y convention, where x is the number of loudspeakers used in the system and y refers to the number of subwoofers used in the system.

Conventional immersive sound systems use discrete loudspeakers placed in each surround channel's prescribed location, and discrete loudspeakers positioned at the recommended locations will result in a high-performance surround sound experience

### BRIEF DESCRIPTION OF THE DRAWINGS

FIG. 1 illustrates an example method that uses a gradient array between two or more transducers in a speaker enclosure in order to create a cardioid directivity pattern that reduces the level of direct-path energy arriving at a listening position from the speaker enclosure for a source channel.

FIG. 2 illustrates an example architecture that implements the techniques of the example method of FIG. 1, among other features.

FIG. 3 illustrates an example computing system.

### DESCRIPTION OF EXAMPLE EMBODIMENTS

Conventional immersive sound systems use discrete loudspeakers placed in each surround channel's prescribed location. While discrete loudspeakers positioned at the recommended locations will result in a high-performance surround sound experience, it is often impractical to install side, rear, and height speakers all around the room.

A single enclosure (or all-in-one) system can be designed to reflect sound off the sidewalls and ceiling in order to simulate a phantom source at the location of the reflection, therefore simulating a discrete loudspeaker at that location. For example, in order to reduce the number of loudspeakers that must be used to implement an immersive sound, an all-in-one system may use transducers on the side of the system to reflect sound off the sidewalls to create one or more phantom horizontal surround channels. Such horizontal surround channels may include, for example, left surround or “Ls,” right surround or “Rs,” left rear surround or “Lrs,” and/or right rear surround or “Rrs” channels. In some embodiments, an all-in-one system may additionally or alternatively use transducers on the top of the system to reflect sound off the ceiling to create one or more phantom vertical surround channels, such as left front height or “Lfh,” right front height or “Rfh,” left rear height or “Lrh,” and/or right rear height or “Rrh” channels.

Reflected phantom sources can serve to replace discrete loudspeakers, but there are some drawbacks to this approach. For example, transducers emit sound omni-directionally at relatively low frequencies, and semi-omnidirectionally in the mid-frequency region. A psychoacoustic phenomenon known as the Haas effect or precedence effect means that a listener who hears two sounds within a short amount of time (e.g., less than 30-40 milliseconds) of each other will perceive the two sounds as a single sound, and will also perceive that sound to occur at the location of the source of the earliest-arriving signal. Thus, a listener will give source-localization precedence to the earliest-arriving sound when two similar sounds arrive within a short amount of time (e.g. less than 30-40 ms) of each other.

In the context of all-in-one systems, because the direct (straight line) pathlength to the listening position is shorter than the reflected pathlength, sound along the direct pathlength arrives first and so will be given source localization precedence by the listener's psychoacoustic perception system. In other words, the sound that follows the shorter, direct path arrives first, and therefore the low and mid-frequency direct-path SPL (Sound Pressure Level) of the source channel will arrive at the listening position before the sound following the reflected path, which causes the listener to perceive the sound as coming from the location of the speaker in the all-in-one system rather than from the reflected location that is meant to simulate a discrete loudspeaker. This effect diminishes the illusion that the source of the surround channel is located at the position of reflection of the reflected phantom source, and therefore reduces or eliminates the ability of all-in-one systems to effectively simulate discrete loudspeakers through reflection.

The techniques of this disclosure use signal processing in an all-in-one system to improve that system's ability to create sound that is perceived at the desired reflected location. As described below, this is achieved by actively controlling the directivity of horizontal (and/or vertical) surround channels of an all-in-one immersive loudspeaker system, and aiming the cardioid null (area of destructive cancelation) at the listening position. If a first-arriving sound is sufficiently lower in level than the second-arriving sound, then the second arrival will be given source localization precedence. Therefore, by reducing the SPL from the direct path, the techniques disclosed herein improve a listener's perception that the sound source is coming from the reflected path, thereby effectively simulating a discrete loudspeaker at the reflected location.

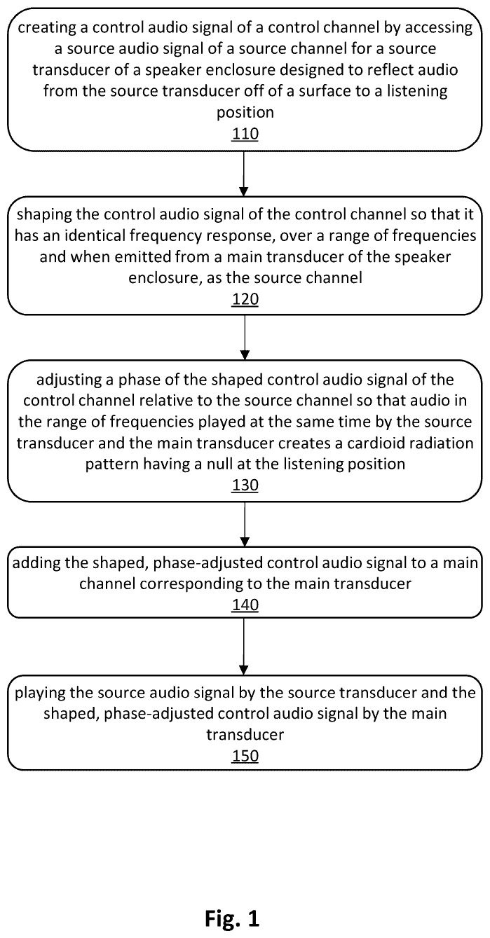

FIG. 1 illustrates an example method that uses a gradient array between two or more transducers in a speaker enclosure in order to create a cardioid directivity pattern that reduces the SPL of direct-path energy arriving at a listening position from the speaker enclosure for a source channel (surround or height channel). A gradient array is achieved when two monopole sources are spaced at a fixed distance apart with one source delayed, filtered, and/or polarity inverted. The physical flight path distance between the two sources is ideally 1/4 wavelength, but the use of linear, or frequency dependent, delay can allow the sources to be moved virtually in space to satisfy the 1/4 wavelength guideline. By implementing a gradient array to impose a cardioid radiation pattern that has the null aimed at the listening position, this causes the listener to localize the source at the reflection (e.g., at the sidewall reflection for horizontal sources) instead of at the speaker, for example increasing the perception that phantom loudspeakers exist at or near their intended locations in a 5.1 or 7.1 loudspeaker setup.

Step 110 of the example method of FIG. 1 includes creating a control audio signal of a control channel by accessing a source audio signal of a source channel for a source transducer of a speaker enclosure designed to reflect audio from the source transducer off of a surface to a listening position. The source channel may correspond to a surround channel or a height channel, as described more fully herein. The speaker enclosure is designed to reflect audio from the source transducer off of a surface to a listening position, thereby creating the illusion of a loudspeaker placed at the reflected location. The speaker enclosure may take any suitable form factor, including but not limited to, bookshelf speakers, tower speakers, stand-alone speakers, modular home theater system, soundbar, TV, etc.

The source transducer is typically a relatively small, full-range driver. This disclosure contemplates that a source transducer can include multiple source transducers such as a two-way configuration. The source transducer may be aimed towards the side (or towards the top) of the speaker enclosure, so that when the speaker enclosure is placed in a room, the source transducer aims at a surface to reflect sound from that surface, e.g., from a wall, a ceiling, a floor, etc. As described above, relatively high frequencies (e.g., above around 5 kHz) tend to be directional, and therefore the reflected sound will be louder at the listening position than the direct-path sound, and thus the reflected sound will take precedence. In contrast, low-frequency and medium-frequency content is more omnidirectional, therefore direct-path sound from the source transducer will arrive first with higher SPL than the reflected sound, meaning that a person at the listening position will perceive the sound as coming from the source transducer rather than from the intended reflected location. In addition, audio content that contains both high frequencies and medium-to-low frequencies will be localized at different locations by the user; for example, if a user is viewing a scene in which a bird is chirping by a waterfall and the source transducer plays the corresponding audio, the listener will tend to hear the high-frequency bird chirp as coming from the reflected location yet hear the medium and low-frequency waterfall as coming from the source transducer location, resulting in dissonance given that they audibly are co-located within the scene.

In order to have the listener perceive the medium and low-frequency content as coming from the reflected location, the techniques of this disclosure use a gradient array. This approach uses two sets of transducers: (1) a set of one or more source transducers, for instance as described with respect to step 110 above, and (2) a set of one or more main transducers. Each main transducer is, for example, a single speaker in the same speaker enclosure as the source transducer. As described herein, the set of main transducers may be a single transducer or may be multiple transducers (e.g., a two-way consisting of a tweeter and a woofer). As described below, the main transducer(s) play audio intended for the main channel (e.g., may play audio for a right channel, front channel, or a center channel, etc.), but simultaneously play a control signal of a control channel derived from the source-audio channel in order to create a cardioid radiation pattern for the source audio resulting a null at the listening position, thereby reducing the direct-path SPL for the source audio relative to the reflected-path SPL for that audio.

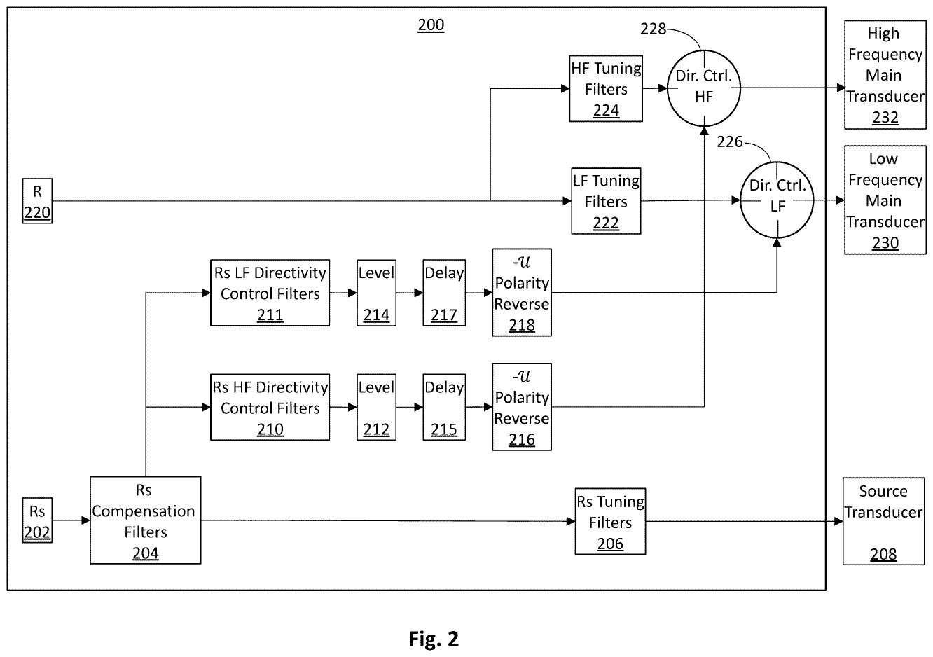

To do so, step 120 of the example of FIG. 1 includes shaping the control audio signal of the control channel so that it has an identical frequency response, over a range of frequencies and when emitted from a main transducer of the speaker enclosure, as the source channel. For instance, step 120 includes filtering the control channel so that, when played by a main transducer, it has an approximately identical acoustical frequency response as the source channel over a band-limited range of frequencies, where the cardioid behavior is desired at a particular horizontal or vertical angle. The frequency shaping can be performed by any type of filter both electrical and acoustical, including but not limited to digital filters such as IIR (Infinite Impulse Response) and FIR (Finite Impulse Response), passive and active analog electrical filters, as well as passive acoustical filters such as 2^{nd} order resonators, 4^{th} order resonators, 6^{th} order bandpass (front and rear resonators), 8^{th} order bandpass (series and/or parallel resonators), etc. Acoustical filters will often employ some type of internal damping and/or acoustical resistance screen to tune the Q of the filters. Here, shaping the control audio signal so that it has the identical frequency response as the source channel at a particular angle, does not require the acoustical frequency responses to be exactly the same, but rather that they be the same within some tolerance. A channel's frequency response changes with each horizontal, or vertical, angle of its corresponding transducer, therefore the filters for the control channel will differ from the filters for the source channel. The bandwidth of filtered frequencies corresponds to the range of frequencies that will be emitted by the main transducer(s) to create the cardioid radiation pattern. As explained with respect to FIG. 2, below, this range of frequencies may be a subset of the full range of the source audio signal.

Step 130 of the example method of FIG. 1 includes adjusting the phase of the shaped control audio signal of the control channel relative to the source channel so that audio in the range of frequencies played at the same time by the source transducer and the main transducer creates a cardioid radiation pattern having a null at the listening position. In particular embodiments, step 130 may include adjusting the acoustical phase relationship so that the frequency dependent 1/4 wavelength requirement of a gradient array is achieved at the desired angle of cancelation towards the listening area. Phase adjustment can be performed with any of the electrical or acoustical filters listed above, but oftentimes this will include the use of an All-Pass-Filter (APF), acoustical resonator, or a delay. The phase of the shaped control channel is adjusted so that the group delay of the main transducer(s) playing the control channel virtually places this source 1/4 wavelength away from the source channel's transducer relative to the listening position over the desired cancelation range of frequencies. In step 130, a polarity reverse is applied to the control channel so that the acoustical domain is out of phase with the source channel towards the angles of the listening position. This causes destructive interference which lowers the SPL at the listening position, which perceptually emphasizes the localization of the source signal from the reflected path. In particular embodiments, the phase is adjusted until a threshold reduction in SPL along the direct path is detected at the listening position; for example, a roughly 10-12 dB reduction relative to the reflected path is typically sufficient to have sound along the reflected path take perceptual localization precedence, even though it arrives after the audio along the direct path.

Step 140 of the example method of FIG. 1 includes adding the shaped (filtered), phase-adjusted control audio signal to a main channel corresponding to the main transducer. In other words, the shaped, phase-adjusted control audio signal is summed with the audio that the main channel is playing for its intended purpose (e.g., the filtered, phase-adjusted control audio signal derived from a source channel corresponding to a transducer serving as the right-surround transducer in the enclosure is summed with a right-channel audio played by a transducer serving as the right (front) channel within the enclosure). Step 150 of the example method of FIG. 1 includes emitting the source audio signal by the source transducer and the shaped, phase-adjusted control audio signal by the main transducer. As described above, the main transducer also plays the audio designated for its channel. As a result of step 150, the combined acoustical SPL from the gradient array creates a cardioid radiation pattern with a null aimed towards the desired area of cancelation at the listening position along the direct path, therefore enhancing the perception that the source audio is emanating from the reflected path.

FIG. 2 illustrates an example architecture that implements the techniques of the example method of FIG. 1, among other features. The example of FIG. 2 illustrates a single main channel 220, which is the front main “right” channel in this example speaker system, and a single source channel 202, which is the “right surround” or “Rs” channel in this example. This disclosure contemplates that the main channel may be any suitable channel (e.g., left-front, center, right-front, etc.) and the source channel may be any surround or height channel. Particular embodiments may have multiple main channels (e.g., a right channel may serve as the main channel to play control signals created from one or more right-side source channels, a left channel may serve as the main channel to play controls signals created from one or more left-side source channels, a center channel may serve as the main channel to play control signals created from one or more central, height surround channels, etc.). As explained throughout, in certain embodiments multiple transducers may by controlled by a single channel (e.g., a left surround, right surround, and height transducer may all be controlled by a generic “front channel”). In particular embodiments, a main channel may serve multiple source channels, e.g., a right channel may serve as the main channel for control signals crated from a right-front height channel, controls signals created from a right-front surround channel, and control signals for a right-rear surround channel, etc. The transducer(s) of each of the source channels would be oriented differently in the enclosure, in order to generate reflections at different areas. In such embodiments, each control channel is added to its main channel in order to create a cardioid radiation pattern having a null at the listening position for the corresponding source channel.

In the example of FIG. 2, the processing is performed by a digital signal processor (DSP) using programmable components such as filters, etc., although this disclosure contemplates that some or all of the processing may be hardwired using fixed hardware. The filters can also be implemented with passive or active electrical filters, as well as acoustical filters.

In the example of FIG. 2, compensation filters 204 are used to compensate for the change in frequency response introduced by processing the audio signal, e.g., by the directivity control filters described herein. In other words, because the presence of the directivity filters in the processing chain alter both the frequency response of the source channel and the control channel (when the processed source signal is added to the main channel), compensation filters 204 reduce or eliminate this alteration. The example of FIG. 2 may use one or more biquad filters as filters 204, although other compensation techniques may be used in addition or the alternative.

In the example of FIG. 2, tuning filters sit on the source channel and on the main channels (i.e., filters 206 and filters 222 and 224, respectively, in the example of FIG. 2). These tuning filters ensure that the audio from each channel has a defined response, and this may vary based on manufacturer or user preferences.

The example of FIG. 2 includes two main transducers: a high-frequency main transducer 232 (e.g., a tweeter) and a low-frequency main transducer 230 (e.g., a woofer). The example of FIG. 2 splits the control channel into two frequency bands: a high-frequency channel using high-frequency directivity control filters 210, and a low-frequency channel using low-frequency directivity control filters 211. Each path separates the control channel in its respective range of frequencies, e.g., using a bandpass filter or low-pass and high-pass filters. For example, the low-frequency control channel may correspond to signals from 150 Hz to 1 kHz, while the high-frequency control channel may filter the signal to a range of frequencies from about 1 kHz (i.e., the upper cutoff of the low-frequency channel) to 4 kHz, for example. While the source audio may itself be between 20 Hz and 20 kHz, the directivity of relatively higher frequencies means that only relatively low and mid-range frequencies (e.g., 20 Hz to 5 kHz) are cancelled using the techniques described herein, in particular embodiments. Moreover, while the example of FIG. 2 illustrates a main channel with two main transducers, this disclosure contemplates that a main channel may use any number of transducers, and the control channel may likewise be split into corresponding frequency bands.

In the example of FIG. 2, control filters 210 and 211 perform the frequency shaping and phase adjustments of steps 120 and 130 of the example method of FIG. 1. For instance, and discussed with respect to step 120, these filters may match the shape of the frequency response of the respective main transducer to the response of the source transducer. For instance, these filters may effectively act as equalizers, adding or removing energy at certain frequencies until the respective transducers have a suitably identical frequency response. These filters may also match the respective levels, or amplitudes, of those channels, e.g., so that the frequency response and amplitude of the source channel at 200 Hz and below matches the frequency response and amplitude of the low-frequency main channel.

In the example, of FIG. 2, filters 210 and 211 also perform the phase adjustment of the shaped control signals, for example using one or more all-pass filters, or any other suitable phase-adjustment technique. This approach inverts the phase of the direct-path audio from the main channel relative to the source audio at the listening position, so that the direct-path audio from the main transducer effectively cancels the direct-path audio from the source transducer at the listening position.

In particular embodiments, filters 210 and 211 may include high-pass filters and low-pass filters to narrow the frequency ranges (i.e., to split the control signal to its respective frequency bands), parametric equalizers, IIR & FIR filters to shape the frequency response, and all-pass filters to adjust the phase, although other approaches may also be used.

In the example of FIG. 2, level blocks 212 and 214 adjust the overall signal amplitude of their respective channels. Delays blocks 215 and 217 are used to adjust the effective position of the main transducers relative to the source transducer, generating sound as if they were farther apart in the speaker enclosure. In essence, adding a delay to a first channel relative to a second channel is akin to moving the transducer playing the first channel farther away (relative to the listening position), and so delays 217 and 215 can be used to essentially modify the effect of the relative physical locations of the transducers in the speaker enclosure. In the example of FIG. 2, polarity reversals 216 and 218 are shown to illustrate the fact that these blocks can be used to invert the polarity of the signal rather than using an all-pass filter, as described above, which can reduce the amount of processing by the DSP chip. However, if the required phase shift occurs in directivity filters 210 or 211, then polarity reversals 216 and 218 would not be used.

As shown in FIG. 2, each processed frequency band of the control signal is then added to the respective main channel, i.e., the processed low-frequency control channel is added 226 to the low-frequency main channel corresponding to transducer 230, while the processed high-frequency control channel is added 228 to the high-frequency main channel that will be played by transducer 232. As explained above, cancellation of the direct-path source audio does not occur within the DSP block 200 itself, but rather occurs in real space in the atmosphere surrounding the loudspeaker system, which lowers direct SPL at the listening position, as a result of the techniques described herein.

As illustrated in the example of FIG. 2, in particular embodiments the control channel may be split into multiple frequency bands, with directivity control and subsequent processing applied to each frequency band. One benefit of this approach is that it provides directivity control over a relatively wider frequency range. This is because different frequencies require different amounts of group delay (using either all-pass filters or delays components) because the phase relationship between two signals is frequency dependent. When the difference between frequencies is small, this effect is not noticeable, but it is noticeable at larger frequency differences (e.g., frequencies at 200 Hz will require a different delay than frequencies at 2,000 Hz in order to cancel at a given listening position). In general, a lower frequency (which corresponds to a longer wavelength) will require a larger delay than will higher frequencies—in other words, satisfying the 1/4 wavelength rule of thumb discussed above is not possible using a single delay across a wide range of frequencies. Therefore, by splitting a control channel into multiple frequency bands (e.g., one from 200 Hz to 1 kHz and one from 1 kHz to 5 kHz), different delays can be targeted to each band, improving cancellation of frequencies in each band at the listening position. Notably, dividing a control signal into multiple frequency bands and applying separate directivity control to each band does not require multiple main transducers; instead, multiple frequency bands can be added to a single main transducer's channel. While the example of FIG. 2 uses two frequency bands and two main transducers, the number of frequency bands may be greater than the number of control transducers.

In particular embodiments, creating a cardioid radiation pattern that has the null aimed at the listening position may be performed using the following example method, although other approaches may be used. First, the speaker enclosure may be placed on a turntable, with a microphone set at the listening position (in other approaches, the microphone may be moved around the speaker, while the speaker remains fixed). The measurement space may be an anechoic chamber so as to eliminate the effect of reflections, leaving only direct-path measurements. The turntable is rotated by certain amounts (e.g., 5 or 10 degrees), and at each position a predetermined audio signal (e.g., a sine-wave sweep) is transmitted by a source transducer and by each main transducer assigned to that source transducer. The complex frequency response from each transducer is recorded (e.g., may be separately recorded, but can be simultaneously recorded in particular embodiments). At the end of the measurement process a complete set of measurements of frequency-dependent sound pressure levels is obtained. This data may be plotted; for example, a common approach is to have the Y axis correspond to the horizontal angle and the X axis correspond to frequency (typically using a logarithmic scale). The sound-pressure-level value at each angle, frequency point in the plot may be indicated by, e.g., color coding.

After obtaining the full set of measurements, then the directivity control and other processing can be tuned until the sound pressure is appreciably reduced (e.g., by 10 dB or more) across the desired frequency range (and, in particular embodiments, within a large enough spatial area so that the listening position is not too spatially narrow). For example, the directivity control may be tuned by a sound engineer observing the plotted measurement data until measurements are obtained or calculated that show the desired direct-path cancellation, although other approaches may be used.

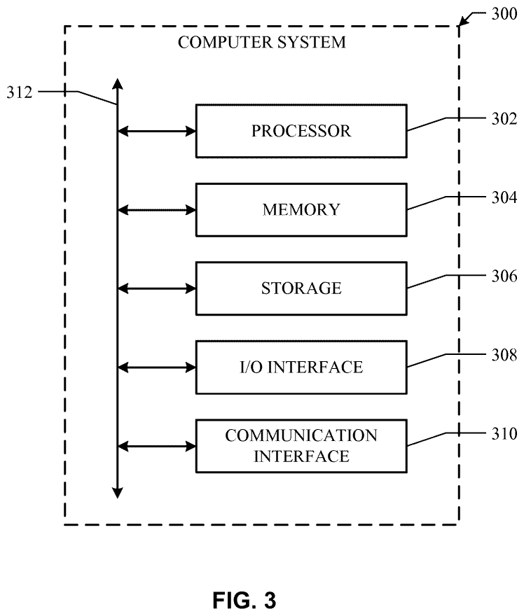

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a digital signal processor that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
creating a control audio signal of a control channel by accessing a source audio signal of a source channel for a source transducer of a speaker enclosure designed to reflect audio from the source transducer off of a surface to a listening position;
shaping the control audio signal of the control channel so that it has an identical frequency response, over a range of frequencies and when emitted from a main transducer of the speaker enclosure, as the source channel;
adjusting a phase of the shaped control audio signal of the control channel relative to the source channel so that audio in the range of frequencies played at the same time by the source transducer and the main transducer creates a cardioid radiation pattern having a null at the listening position;
adding the shaped, phase-adjusted control audio signal to a main channel corresponding to the main transducer; and
emitting the source audio signal by the source transducer and the shaped, phase-adjusted control audio signal by the main transducer.

2. The method of claim 1, wherein the reflected audio off of the surface to the listening position lies in a horizontal plane relative to the speaker enclosure and the listening position.

3. The method of claim 2, wherein the main transducer comprises a plurality of main transducers.

4. The method of claim 3, wherein the plurality of main transducers comprise a woofer and a tweeter, and the main channel comprises a low-frequency main channel corresponding to the woofer and a high-frequency main channel corresponding to the tweeter.

5. The method of claim 4, further comprising splitting the control audio signal into a low-frequency control channel and a high-frequency control channel, wherein:
shaping the control audio signal and adjusting the phase of the shaped control audio signal comprises separately shaping and phase-adjusting the low-frequency control channel and the high-frequency control channel; and
adding the shaped, phase-adjusted control audio signal to the main channel comprises adding the shaped, phase-adjusted low-frequency control channel to the low-frequency main channel and adding the shaped, phase-adjusted high-frequency control channel to the high-frequency main channel.

6. The method of claim 5, wherein separately phase-adjusting the low-frequency control channel and the high-frequency control channel comprises applying a larger delay to the low-frequency control channel than to the high-frequency control channel.

7. The method of claim 2, further comprising splitting the control audio signal into a plurality of different frequency bands, wherein:
shaping the control audio signal and adjusting the phase of the shaped control audio signal comprises separately shaping and phase-adjusting each of the plurality of different frequency bands of the control audio signal; and
adding the shaped, phase-adjusted control audio signal to the main channel comprises adding each of the shaped, phase-adjusted plurality of frequency bands of the control audio signal to the main channel.

8. The method of claim 7, wherein separately phase-adjusting each of the plurality of different frequency bands of the control audio signal comprises applying a different delay to each frequency band of the control audio signal.

9. The method of claim 8, wherein:
the main transducer comprises one or more main transducers; and
at least two of the plurality of different frequency bands of the control audio signal are played by a single one of the one or more main transducers.

10. A digital signal processor comprising: one or more non-transitory computer readable storage media storing instructions, and one or more processors coupled to the one or more non-transitory computer readable storage media and operable to execute the instructions to:
create a control audio signal of a control channel by accessing a source audio signal of a source channel for a source transducer of a speaker enclosure designed to reflect audio from the source transducer off of a surface to a listening position;
shape the control audio signal of the control channel so that it has an identical frequency response, over a range of frequencies and when emitted from a main transducer of the speaker enclosure, as the source channel;
adjust a phase of the shaped control audio signal of the control channel relative to the source channel so that audio in the range of frequencies played at the same time by the source transducer and the main transducer creates a cardioid radiation pattern having a null at the listening position;
add the shaped, phase-adjusted control audio signal to a main channel corresponding to the main transducer; and
provide the source audio signal for playback by the source transducer and the shaped, phase-adjusted control audio signal for playback by the main transducer.

11. The digital signal processor of claim 10, wherein the reflected audio off of the surface to the listening position lies in a horizontal plane relative to the speaker enclosure and the listening position.

12. The digital signal processor of claim 11, wherein the main transducer comprises a plurality of main transducers.

13. The digital signal processor of claim 12, wherein the plurality of main transducers comprise a woofer and a tweeter, and the main channel comprises a low-frequency main channel corresponding to the woofer and a high-frequency main channel corresponding to the tweeter.

14. The digital signal processor of claim 13, further comprising one or more processors that are operable to execute the instructions to split the control audio signal into a low-frequency control channel and a high-frequency control channel, wherein:
shaping the control audio signal and adjusting the phase of the shaped control audio signal comprises separately shaping and phase-adjusting the low-frequency control channel and the high-frequency control channel; and
adding the shaped, phase-adjusted control audio signal to the main channel comprises adding the shaped, phase-adjusted low-frequency control channel to the low-frequency main channel and adding the shaped, phase-adjusted high-frequency control channel to the high-frequency main channel.

15. The digital signal processor of claim 14, wherein separately phase-adjusting the low-frequency control channel and the high-frequency control channel comprises applying a larger delay to the low-frequency control channel than to the high-frequency control channel.

16. The digital signal processor of claim 11, further comprising one or more processors that are operable to execute the instructions to split the control audio signal into a plurality of different frequency bands, wherein:
shaping the control audio signal and adjusting the phase of the shaped control audio signal comprises separately shaping and phase-adjusting each of the plurality of different frequency bands of the control audio signal; and
adding the shaped, phase-adjusted control audio signal to the main channel comprises adding each of the shaped, phase-adjusted plurality of frequency bands of the control audio signal to the main channel.

17. The digital signal processor of claim 16, wherein separately phase-adjusting each of the plurality of different frequency bands of the control audio signal comprises applying a different delay to each frequency band of the control audio signal.

18. The digital signal processor of claim 17, wherein:
the main transducer comprises one or more main transducers; and
at least two of the plurality of different frequency bands of the control audio signal are played by a single one of the one or more main transducers.

19. A speaker enclosure comprising:
a plurality of transducers comprising a source transducer and a main transducer; and
a digital signal processor configured to:
create a control audio signal of a control channel by accessing a source audio signal of a source channel for the source transducer of the speaker enclosure designed to reflect audio from the source transducer off of a surface to a listening position;
shape the control audio signal of the control channel so that it has an identical frequency response, over a range of frequencies and when emitted from the main transducer of the speaker enclosure, as the source channel;
adjust a phase of the shaped control audio signal of the control channel relative to the source channel so that audio in the range of frequencies played at the same time by the source transducer and the main transducer creates a cardioid radiation pattern having a null at the listening position;
add the shaped, phase-adjusted control audio signal to a main channel corresponding to the main transducer; and
provide the source audio signal for playback by the source transducer and the shaped, phase-adjusted control audio signal for playback by the main transducer.

20. The speaker enclosure of claim 19, wherein the reflected audio off of the surface to the listening position lies in a horizontal plane relative to the speaker enclosure and the listening position.
